(19) United States
(12) Patent Application Publication
(10) Pub. No.: US 2002/0083207 A1
(43) Pub. Date: Jun. 27, 2002

(54) Method and system for accessing an IP network and for working in it

(76) Inventor: Frank-Uwe Andersen, Berlin (DE)

Correspondence Address: BELL, BOYD & LLOYD, LLC, P. O. BOX 1135, CHICAGO, IL, 60690-1135, US

(21) Appl. No.: 09/981,561

(22) Filed: Oct. 15, 2001

(30) Foreign Application Priority Data
Oct. 16, 2000 (DE) 100 51 147.3

(51) Int. Cl. G06F 15/16; G06F 15/163; G09G 5/00

(52) U.S. Cl. 709/249; 709/227; 709/311; 345/864

(57) ABSTRACT

A method and system for accessing an IP network, in particular the Internet, and for working with it or with resources connected to it, in which case, in the IP network, a first session on the basis of a standard protocol, in particular the HTTP, and, via a user interface that is unrestricted at least on the output side, and in parallel therewith, a second session on the basis of a restricted protocol, in particular the WAP, and/or via a restricted user interface, are established and maintained in such a way that the first and second sessions are connected by an interprocess communication to form a hybrid session.

### BACKGROUND OF THE INVENTION

The present invention relates to a method for accessing an IP network, in particular the Internet, and for working with it or with resources connected to it, and further relates to a system for carrying out this method.

For years, the development of the Internet into a worldwide information, communication and trade infrastructure, and the no less dynamic development of mobile telecommunications, have been formative factors for economic and social development in the industrialized countries. The Internet, in addition to its use as a source of communication and a source of information for hundreds of millions of people, is increasingly gaining in importance as a shopping source. An appreciable proportion of, in particular, trade in software, books and travel already proceeds over the Internet (specifically, the World Wide Web), but increasingly a broad spectrum of other goods and services is also being ordered and paid for over the Internet. The diverse possibilities in respect of auctions, prize games and communications (chat forums) are also attracting a continually increasing number of users.

The fast, large-scale propagation of the Internet to become a worldwide data network largely can be attributed to the performance of the standard protocol that regulates the data communication; namely, the HTTP (Hypertext Transfer Protocol). On the basis of this protocol or the TCP protocol, as is known, not only text messages but also voice messages (Voice over IP), graphics, still images and moving images can be communicated over the Internet. They can be output on terminals of protocol-conforming design (for images, for example, on VGA color monitors) with high quality. Virtual reality scenes through which one can move also can be transmitted over the WWW in the form of VRML documents. Using links embedded in WWW documents, it is also possible to call up further documents, which may be stored on other servers.

Of no less significance is the development of mobile telecommunications. For a majority of people in the industrialized countries, the mobile telephone (“mobile phone”) is increasingly becoming a universal communication and information tool. It is also increasingly being utilized for ordering and paying for goods and services. The dynamics of this development have increased as a result of the introduction of the mobile-radio-conforming standard WAP (Wireless Application Protocol) for access to the Internet via mobile telephones. On the basis of this protocol and the associated programming language WML (Wireless Markup Language), users of appropriately equipped mobile telephones can call up information and services from the Internet.

For this purpose, a special Internet browser, the WAP browser, is implemented in the mobile telephone. By contrast, standard access to the WWW is effected via a web browser incorporated in the corresponding terminals.

The limitations inherent in the current mobile radio standard GSM with regard to the transmission bandwidth and speed unavoidably result in quite significant restrictions in the utilization of the Internet or of resources connected thereto via the WAP mobile phone. Apart from the fact that only correspondingly prepared Internet pages in the WML format can be accessed at all (which do not provide all the companies and facilities present in the network, to say nothing at all of private individuals), the input and output processes are laborious and slow. Transmitting sophisticated graphics and images onto the display of a mobile phone is hardly practical, and it is not possible to represent color and moving images.

Contrasting with these disadvantages is, however, the major advantage of the possibility of mobile access to the Internet and its resources. Moreover, the current mobile radio standards enable extremely reliable authentication of the user for network access in a simple manner.

The present invention is, therefore, directed toward specifying an improved method of the generic type and a corresponding arrangement which afford significantly extended possibilities of utilization of the Internet for mobile telephone users.

### SUMMARY OF THE INVENTION

The present invention includes the basic concept, in the case of access to an IP network (specifically, the Internet) of establishing a hybrid session from two sessions that run in parallel with one another and are based on different protocols. This makes it possible to preserve the advantages of mobile access to the IP network and, at the same time, to largely eliminate the limitations of the GSM mobile radio networks for the user.

Since, in particular, one of the two sessions proceeds in a manner utilizing the standard protocol HTTP (or TCP), the abovementioned hybrid session allows for the possibilities of the IP network that are afforded with the standard protocol also to be largely available to the user effecting access via his/her mobile telephone. At the same time, such user has the advantage of mobile access, with the result that (e.g., in applications that will be explained in more detail further below) he/she can work in the IP network as it were using a “remote control”. In a sense, the present invention creates a remote control or telecontrol gateway. It reduces parallel communication operations on separate paths to a simple interprocess communication between two IP network access and work processes on a computer (server).

In particular, unlike on the display of the WAP mobile telephone, color representations with high resolution and also representation of moving images are possible. The proposed method also affords advantages for the application of displaying a text document, which application is relatively simple and can be managed well by a WAP mobile phone in terms of transmission technology. Specifically, the multiple shifting (irksome to the user) of the display zone when studying a somewhat longer text is obviated since the display can be effected on a large screen.

Finally, access via the mobile telephone affords the possibility already mentioned above of very simple and relatively reliable user authentication and of the high monitoring security that is intrinsic to the GSM standard. This has a beneficial effect, in particular, for commercial transactions over the Internet. Once a control connection has been established between the WAP mobile telephone and an Internet server, the further progression of the method can take place solely using a separate output device; specifically, a color monitor with a large screen. The implementation of the method requires only this screen and an Internet connection, but no keyboard and none of the customary peripheral components of a PC. All inputs can be effected on the mobile telephone. In this respect, the proposed method also can be used, in principle, in conjunction with an Internet access via a television set.

For the hybridization of the two abovementioned sessions or network access types (WAP and “WEB”, respectively), use is made, in particular, of a computer (“WEB server”) equipped with JAVA servlets, the data streams of the WAP and WEB session, respectively, interacting via a known interprocess communication.

In addition to the abovementioned variant of the initiation of the hybrid session via the mobile telephone as a terminal with restricted protocol capability, this initiation (specifically, the establishment of the session that proceeds with the standard protocol) also can be effected via a terminal with full protocol capability; that is to say, in particular, a PC operating according to the HTTP protocol. Furthermore, the use of a PC with the customary functionality is possible in addition to the abovementioned embodiment with a straightforward (optical) output device as a “terminal” of the standard protocol session. In that case, if appropriate, inputs can be effected both via the peripherals of the PC and via the keyboard or, if appropriate (via voice control), also via the talking capsule of the mobile telephone.

An interesting application of the proposed method consists in using the mobile telephone to control display operations proceeding on the output device or terminal operating in accordance with the standard protocol; for example, in the context of a Powerpoint presentation. Assuming appropriate equipment, a large-screen television set advantageously can be used for this purpose, for example.

A further interesting application is “Internet shopping through the shop window”, in which a mobile telephone user can use his/her mobile phone to set up a WAP session in parallel with a standard protocol session which runs (permanently) on a PC behind the shop window of a closed shop or else on a PC or automatic goods vending machine installed especially for this purpose in a public space. The provider's web page represented on the monitor instructs the mobile telephone user about the possibility and procedure for access to the offer presented and takes the user through the steps of the ordering and payment operation, which he/she implements using his mobile phone.

It goes without saying that the proposed solution also can be used for further applications of the utilization of Internet resources and for other remote control operations via mobile telephone and Internet.

The above explanations already make it clear that the proposed solution also has apparatus aspects corresponding to the method aspects, which include, in particular, the provision of two terminals, of which one has the full protocol capability of the IP network and the other has a restricted protocol capability, and also of a server which can establish the two abovementioned sessions and for ensuring the interprocess communication between them. In particular, the JAVA servlets already mentioned are involved in this case. In the most preferred embodiment at the present time, one of the terminals or the output device is a PC with web browser, while the other terminal is a WAP mobile telephone.

Additional features and advantages of the present invention are described in, and will be apparent from, the following Detailed Description of the Invention and the Figures.

### BRIEF DESCRIPTION OF THE FIGURES

FIG. 1 shows a sketch-like illustration in the form of a function block diagram for elucidating a first embodiment of the present invention.

FIG. 2 shows a sketch-like illustration in the form of a function block diagram for elucidating a second embodiment of the present invention (remote control application).

FIG. 3 shows a sketch-like illustration in the form of a function block diagram for elucidating a third embodiment of the present invention (shopping application).

FIG. 4 shows a sketch-like illustration in the form of a function block diagram for elucidating a fourth embodiment of the present invention (infopoint application).

### DETAILED DESCRIPTION OF THE INVENTION

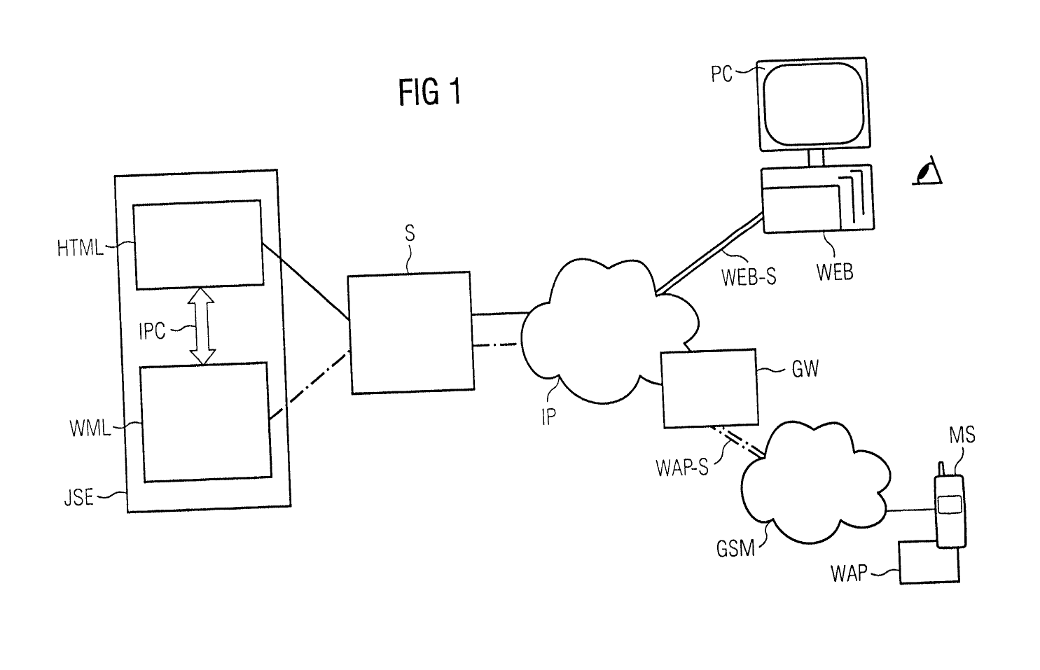

The arrangements shown in FIGS. 1 to 4 largely have the same construction, so that in this respect the same reference numerals are used and the explanations given with regard to FIG. 1 are not repeated afterward.

FIG. 1 diagrammatically shows a basic architecture for the presently preferred embodiment of the present invention. A mobile telephone MS is connected to the Internet IP via a GSM mobile radio network GSM (whose construction is assumed to be known here) and a gateway server GW, there being a web server S in the Internet. The web server is assigned a JAVA servlet engine JSE in which an HTML “creation” HTML for a conventional Internet browser and also a WML creation WML for a WAP browser are implemented. Between these there is an interprocess communication IPC.

In addition to the mobile telephone MS, a conventional personal computer PC is also connected to the Internet IP. The abovementioned Internet browser WEB is implemented in the personal computer while a WAP browser WAP is implemented in the mobile telephone. An HTTP session WEB-S is established on the Internet via the personal computer PC, while a WAP session WAP-S is established via the mobile telephone MS.

As already explained above, the user controls the two mutually interacting sessions WAP-S and WEB-S via the mobile telephone MS while visually observing the screen of the personal computer PC and all the relevant information is displayed to him/her on an HTTP basis with high resolution and speed via the screen.

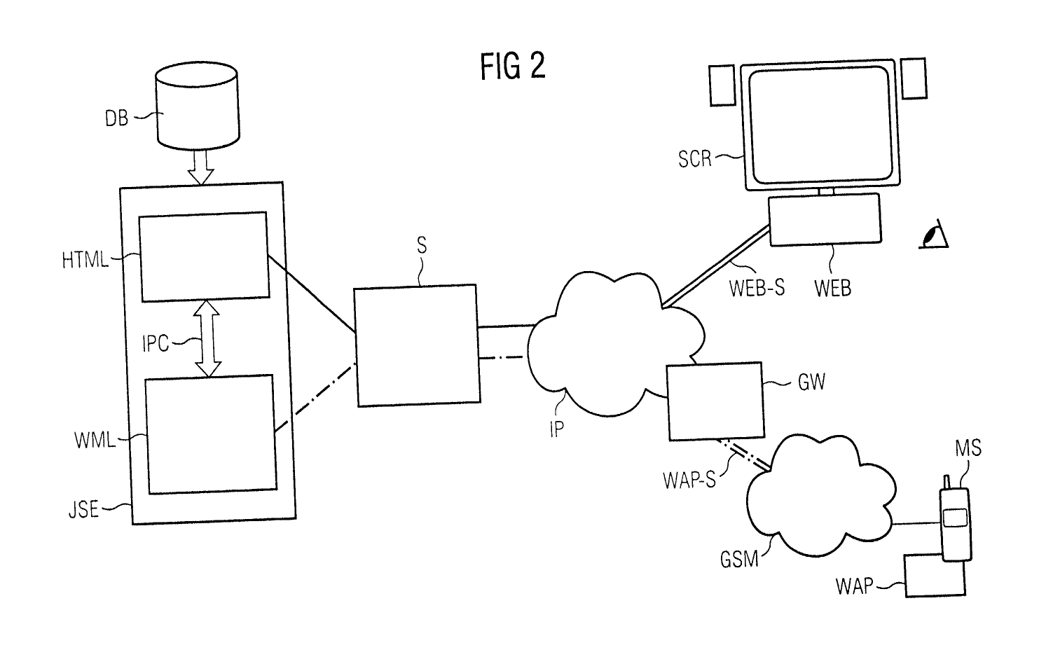

FIG. 2, largely following the illustration according to FIG. 1, sketches as a first essential application the control of a Powerpoint presentation on a large screen SCR via the mobile telephone MS. It goes without saying that the large screen SCR is assigned a computer with standard Internet browser WEB. A complete PC is not provided in this application.

The Netscape Navigator is used as the standard Internet browser here because a MULTIPART MIME content is preferably utilized for displaying the graphics data on the large screen. The mobile telephone can be used to issue, in particular, the commands “Forward”, “Back” and “Exit” (to end the web session). PDUs which correspond to these commands and are transferred from the servlet of the WAP session to the servlet of the WEB session replace key inputs on the fixedly connected terminal.

The individual representations for the presentation are converted beforehand into a browser-readable graphics format (for example, JPG or GIF) and are read from a database system DB prior to the transfer to the (passively waiting) standard Internet browser WEB.

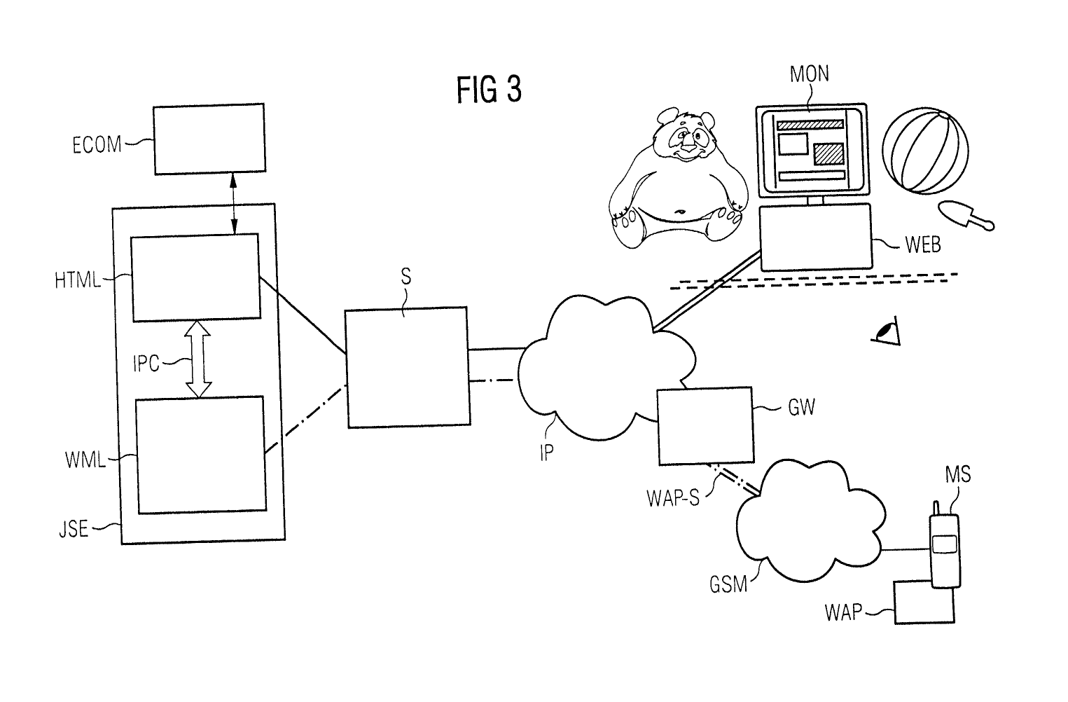

FIG. 3 sketches as a further application Internet shopping utilizing a monitor MON installed in the shop window of a shop beside a range of goods for sale. All of the logic ECOM for handling electronic transactions is implemented in the JAVA servlet engine JSE of the server S. It ensures that a user guide can be displayed on the monitor MON and be processed as required step by step via the mobile telephone MS, via ordering through to payment.

In this application, the simple and reliable authentication of the user via the SIM card of his/her mobile telephone and the input PIN is particularly advantageous since, under certain circumstances, it makes it possible to dispense with additional security mechanisms. On the other hand, the large, high-resolution merchandise presentation and menu guide on the color monitor of the shop is considerably attractive to the user compared with the small, difficult-to-read display of his/her mobile telephone.

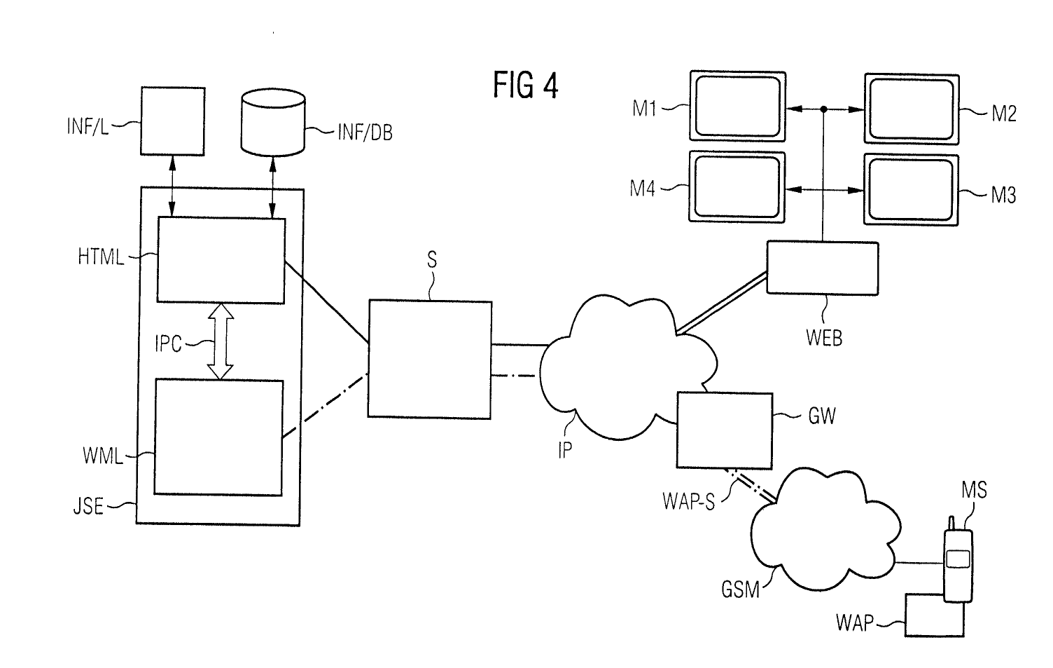

Finally, FIG. 4 sketches as a further exemplary embodiment an information system with distributed display screens M1 to M4 and a common standard Internet browser WEB. In this case, too, a logic system INF/L and also a database INF/DB for operating the information system are implemented in the Internet server S or the JAVA servlet engine JSE.

With the aid of the monitors, which are installed at preferred public locations, passing potential Internet users can use their mobile telephone MS to access the Internet and then carry out, with the assistance of the powerful representation possibilities of HTTP, the work they desire in the network. In this case, the display units are to a certain extent “personalized” for the users of the mobile telephones via the mobile telephones. As in the previous examples as well, the participating HTTP connections can be cryptographically secured via SSL.

In this case, the monitors M1 to M4 serve exclusively as display units, require no keyboard and no access possibility for the user and can, therefore, be installed in a manner that protects them against ambient influences and vandalism, even in the open.

The embodiment of the present invention is not restricted to the above-described examples and emphasized aspects, but rather, in the context of the claims, is equally possible in a multiplicity of modifications which lie within the scope of expert action.

In addition to the embodiment mentioned a number of times above, with a WAP mobile telephone as a terminal with restricted protocol capability with regard to the standard IP protocol, the present invention also can be embodied with a data terminal which, although designed to process the standard IP protocol, nevertheless has restricted input and/or output possibilities; for example, via a display screen of small size and/or resolution. The present invention also can be embodied with mobile radio terminals of future generations (in particular, UMTS terminals) which are largely adapted to the processing of HTTP or TCP but necessarily have a small display and do not have a full alphanumeric keyboard. For devices of this type, the term “restricted user interface” is used in the appended claims.

Indeed, although the present invention has been described with reference to specific embodiments, those of skill in the art will recognize that changes may be made thereto without departing from the spirit and scope of the invention as set forth in the hereafter appended claims.

1. A method for accessing and working with an IP network and resources connected to the IP network, the method comprising the steps of:
establishing and maintaining, in the IP network, a first session based on a standard HTTP protocol via a user interface that is unrestricted at least on an output side;
establishing and maintaining, in the IP network and in parallel with the first session, a second session based on at least one of a restricted WAP protocol, and a restricted user interface; and
connecting the first and second sessions by an interprocess communication to form a hybrid session.

2. A method for accessing and working with an IP network as claimed in claim 1, wherein the IP network is the Internet.

3. A method for accessing and working with an IP network as claimed in claim 1, wherein the establishment o f the first session is driven via a first terminal with full protocol capability and directly via an IP network server with full protocol capability, wherein the establishment of the second session is driven, after the establishment of the first session, via a second mobile radio terminal with restricted protocol capability, operating according to the WAP and via a WAP gateway, and wherein the first session is continued using the first terminal at least as an output device and the second session is continued using the second terminal as an input device.

4. A method for accessing and working with an IP network as claimed in claim 1, wherein the establishment of the first and second sessions is driven via at least one of a mobile radio terminal with restricted protocol capability operating according to the WAP and via a WAP gateway and a restricted user interface via an IP network server with full protocol capability, and wherein the first session is continued using a separate output device and the second session is continued using its respective terminal as an input device.

5. A method for accessing and working with an IP network as claimed in claim 4, wherein the output device is designed and utilized as a second terminal for inputs in the course of the first session.

6. A method for accessing and working with an IP network as claimed in claim 1, wherein the step of connecting the first and second sessions to form the hybrid session is executed by JAVA servlets implemented in the IP network server.

7. A method for accessing and working with an IP network as claimed in claim 6, wherein a sequence of the first session and the outputs effected during the first session are substantially controlled by a JAVA servlet of the second session.

8. A method for accessing and working with an IP network as claimed in claim 3, the method further comprising the step of:
performing an authentication of the user during the establishment of one of the first session and the second session via the second terminal.

9. A method for accessing and working with an IP network as claimed in claim 3, the method further comprising the step of:
effecting a sequence control of a display operation proceeding on one of the first terminal or an output terminal via the mobile radio terminal with restricted protocol capability.

10. A method for accessing and working with an IP network as claimed in claim 3, the method further comprising the step of:
effecting at least one of ordering and paying of goods and services in the context of a menu guide which is at least partly displayed on one of the other terminal and an output terminal via inputs on the mobile terminal with restricted protocol capability.

11. A system for accessing and working with an IP network and resources connected to the IP network, the system comprising:
a first mobile radio terminal with restricted WAP protocol capability with regard to a standard HTTP protocol and restricted user interface;
a second terminal with full protocol capability with regard to the standard HTTP protocol and unrestricted user interface; and
an IP network server connectable to the first and second terminals, the IP network server for establishing and maintaining a first session based on the standard HTTP protocol and via a user interface that is unrestricted at least one an output side, for establishing and maintaining a second session, in parallel with the first session, based on the restricted WAP protocol and via a restricted user interface, such that the first and second sessions are connected by an interprocess communication to form a hybrid session.

12. A system for accessing and working with an IP network as claimed in claim 11, wherein the IP network server includes JAVA servlets for the establishment of the first and second sessions and the maintenance of the first and second sessions as the hybrid session.

13. A system for accessing and working with an IP network as claimed in claim 11, further comprising:
a WAP gateway connected between the mobile radio terminal operating according to the WAP and the IP network server.
